(19) United States
(12) Patent Application Publication
(10) Pub. No.: US 2007/0293192 A9
(43) Pub. Date: Dec. 20, 2007

(54) Identification of a terminal to a server

(75) Inventor: Max De Groot, La Bouilladisse (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/529,213

(22) PCT Filed: Sep. 26, 2003
(86) PCT No.: PCT/FR03/02837

§ 371 Date: Dec. 7, 2005

(30) Foreign Application Priority Data
Sep. 26, 2002 (FR) 02/11944

(51) Int. Cl. H04M 1/66

(52) U.S. Cl. 455/411; 455/558

(57) ABSTRACT

A chip card in a terminal such as a mobile radiotelephone is identified by a first identifier with a server including for example the nominal locating recorder in a cellular radiotelephone network, without the first identifier being transmitted in a clear form or substituted by a provisional identifier. An anonymous identifier is determined in the card on the basis of a generated random number, the first identifier and the result of a public key asymmetric algorithm to which at least the random number is applied. The anonymous identifier is transmitted to the server which recovers the first identifier at least by executing the asymmetric algorithm to which a private key and at least partly the anonymous identifier are applied.

The present invention relates to the identification of a user terminal, and more particularly of a portable electronic object belonging, to a user such as a chip card, or indeed of a user of the terminal to a server. The identification is used to access, by means of such a telecommunication network, a service provided by the server resource, such as the setting-up of a call with another user terminal.

It is known that a user with a radiotelephone terminal must identify himself to a server in any telecommunication network in order to gain access to a service. To this end, an identifier identifying the terminal or the user is transmitted at least once in clear from the terminal to the server. Then, in the messages exchanged between the terminal and the server, the identifier is also present. This allows the administrator of the server to handle the proposed service as a function of the data associated with the subscription of the user, and to handle the billing of the service.

In such a terminal-client/server system, an attacker can detect the identifier of the terminal or of the user in the messages transmitted by the terminal in order to locate the latter and, for example, to intercept and to time and date the messages transmitted from the terminal to the server.

In a cellular radiotelephone system of the GSM type, each mobile terminal is identified by a unique international identifier (IMSI—International Mobile Subscriber Identity). For reasons of security, the (IMSI) identifier is transmitted through the radio interface between the mobile terminal of the user and the fixed network of the radiotelephone network only very rarely, such as after switching on the terminal or after a loss of radio coverage of the terminal. In order to protect the confidentiality of the identifier of the IMSI user, a temporary IMSI identifier (Temporary Mobile Subscriber Identity) replaces the IMSI identifier every time the mobile terminal must identify itself to the fixed network of the radiotelephone system. The TMSI temporary identifier is transmitted by the visitor location register (VLR) to which the mobile terminal is attached momentarily at each switch-on of the mobile terminal, or if appropriate, during a change of VLR register for a transfer of the terminal between location zones.

During certain exchanges between the mobile terminal and the VLR register however, after a first switch-on of the terminal, the unique IMSI identifier can be intercepted. The later transmission of the TMSI temporary identifier does not remedy the substitution of the IMSI identifier for the user by a fraudulent attacker.

Furthermore, the change of temporary identifier is determined by the fixed network of the radiotelephone network, and in a general manner by the server resource in the fixed network containing the VLR register, which prevents any control of the handling of his personal identifier by the user at the mobile terminal level.

The object of the invention is to overcome these drawbacks in order not to transmit the personal identifier of the terminal or of the user in clear to the server during a session between the terminal and the server, including during the establishment of the latter, and more generally every time the identifier has to be transmitted using the previous technique, while also allowing an identification of the terminal or of the user to the server, as well as management of an identifier actually transmitted at the terminal level.

To this end, a process to identify user terminal resource or a user of the terminal resource by a server resource through such a communication network, using a first identifier, where an asymmetrical algorithm with public key is implemented in the terminal resource, is characterised by:

the generation of a random number in the user terminal resource,

the determination in the terminal resource of a second identifier as a function of the random number, at least from part of the first identifier and from the result of executing the asymmetrical algorithm to which at least the random number is applied,

transmission of the second identifier to the server resource and,

in the server resource, retrieval of the first identifier at least by executing the asymmetrical algorithm to which a private key and, at least partially the second identifier, are applied so that the server resource verifies that the first identifier retrieved is written into a memory of the server resource.

When at least one authentication of the terminal resource by the server resource, or a mutual authentication of these, is included, then the above-mentioned steps of the process of the invention precede the authentication process.

As a result of the determination of a second identifier and the transmission of the latter to the server resource, the first personal identifier of the user of the terminal is never transmitted by the terminal resource to the server resource. This means that the first identifier can be all or part of the IMSI user identifier in order for a mobile terminal in a cellular radiotelephone system of the GSM type to remain protected in the terminal resource. The second identifier can be transmitted by the terminal resource to the server resource at the beginning of a call, that is during the setting-up of a call or during the setting-up of a session, so that the server decrypts the second identifier in the first identifier of the user and so identifies the user.

Any change in the second identifier is produced by the generation of another random number in the terminal resource. The terminal resource thus handles changes in the second identifier locally, independently of the server resource, as a function of particular events, or periodically, or indeed manually at the request of the user.

In order to further increase the security of the first identifier of the user, the public key necessary for execution of the asymmetrical algorithm in the terminal resource, in order to produce the second identifier to be transmitted, can be modified as desired by the server resource, preferably after a prior authentication of the server resource by the terminal resource. In this event, the process of identification according to the invention can include a change of public key and of private key for the asymmetrical algorithm in the server resource, and downloading of the changed public key from the server resource to the terminal resource.

The invention also relates to a user terminal resource, mainly a chip card, identifying itself or identifying a user of the latter to a server resource, for implementation of the identification process according to the invention. The terminal resource is characterised in that it includes:

a resource for the generation of a random number, and

a resource to determine a second identifier as a function of the generated random number, at least from part of the first identifier and from the result of executing the asymmetrical algorithm to which at least the random number is applied, in order to transmit the second identifier to the server resource, which retrieves the first identifier at least by executing the asymmetrical algorithm to which a private key and, at least partially, the second identifier are applied, and which verifies that the first identifier retrieved is written into a memory of the server resource.

For example, the resource to generate a random number and the resource to determine a second identifier are included in a portable electronic object of the chip card type.

Other characteristics and advantages of the present invention will appear more clearly on reading the following description of several preferred embodiments of the invention, with reference to the corresponding appended drawings in which:

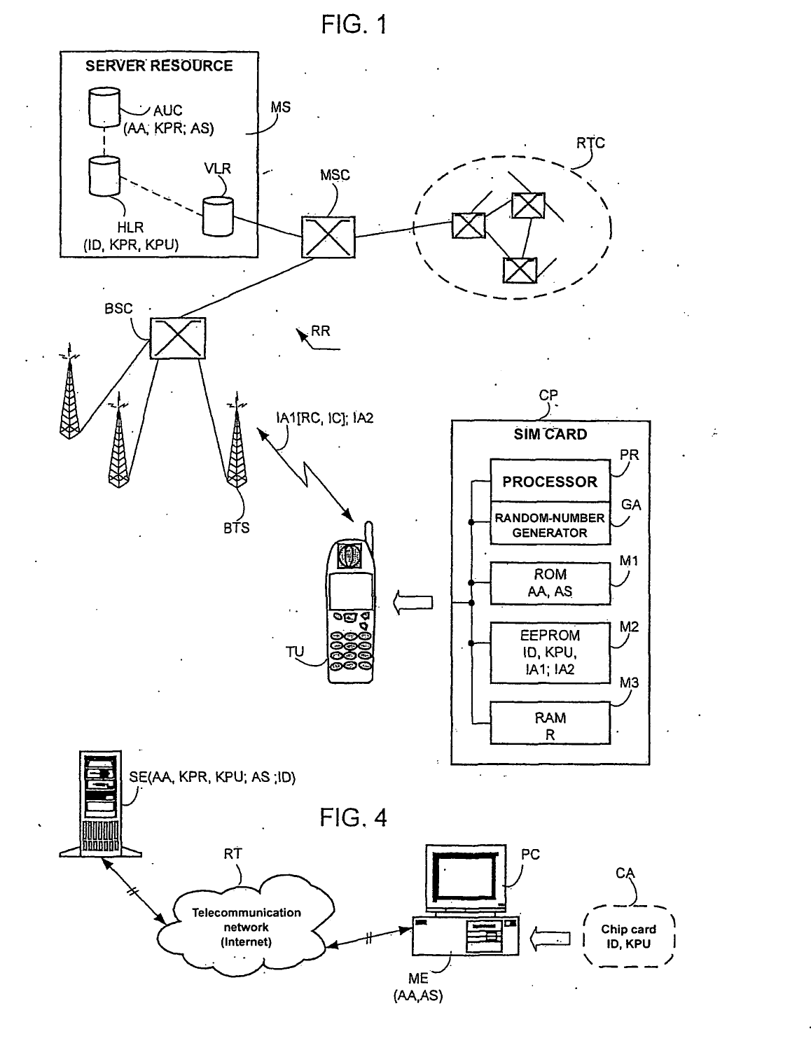

FIG. 1 is a schematic block diagram of a digital cellular radiotelephone according to a first example of implementation of the process of the invention, in which the terminal resource essentially comprises an identity module of the SIM card type;

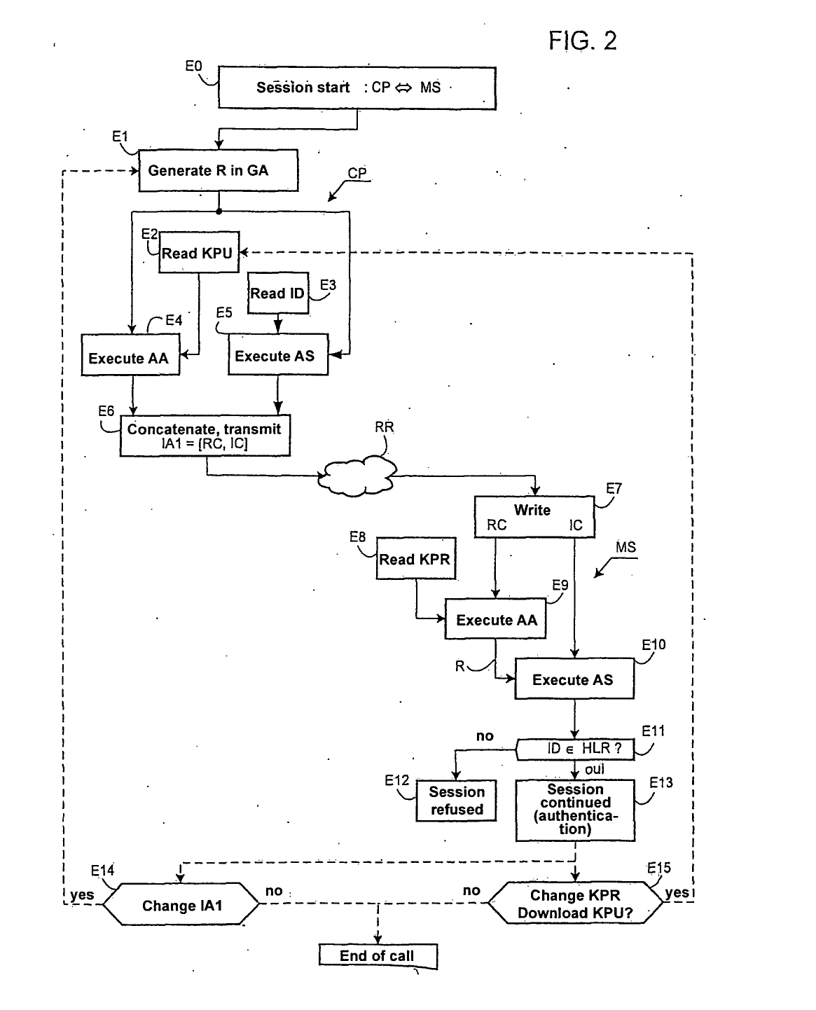

FIG. 2 shows some steps of the identification process according to a first embodiment of the invention which makes use of an asymmetrical algorithm and a symmetrical algorithm;

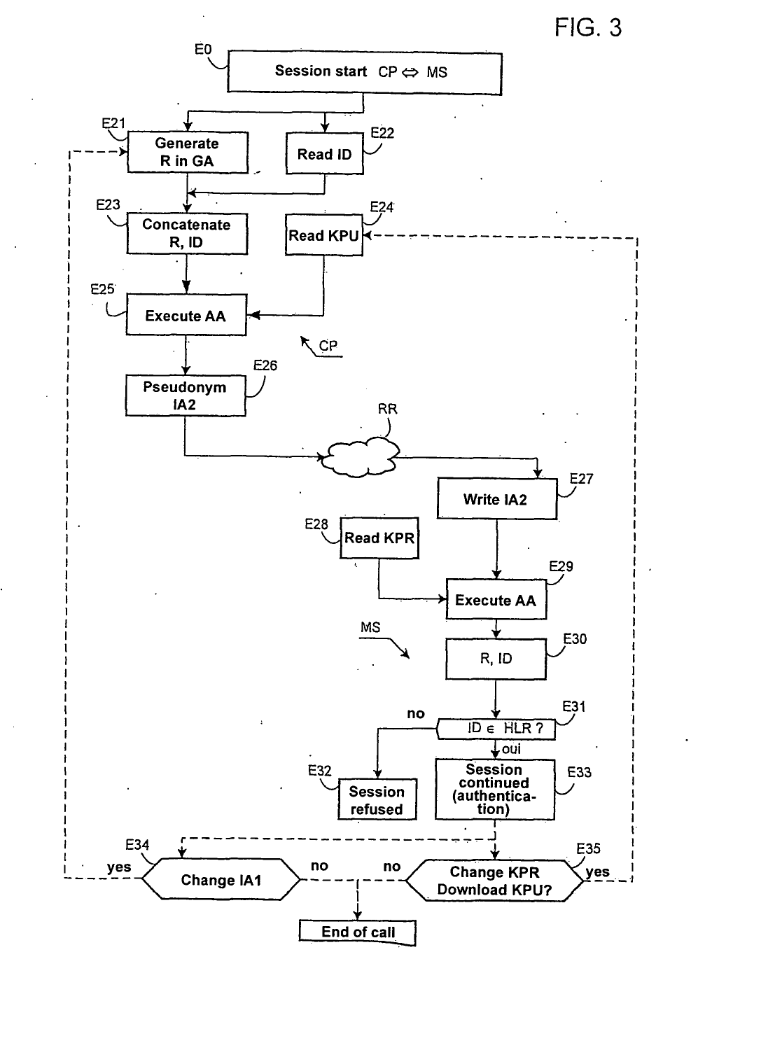

FIG. 3 shows some steps of the identification process according to a second embodiment of the invention which employs only an asymmetrical algorithm; and

FIG. 4 is a schematic block diagram of such a telecommunication network between a terminal of the personal computer type and a server according to a second example of implementation of the process according to the invention.

According to a first example of the client/server architecture of the invention shown in FIG. 1, the user terminal resource is composed of a user mobile radiotelephone terminal (TU), and more particularly of a removable module called a SIM card (Subscriber Identity Module) of the chip card type (CD), also called a micro-controller card, included in the terminal (TU).

At any given instant, the user radiotelephone terminal (TU) is situated in a location zone of a digital cellular radiotelephone system (RR), of the GSM or UMTS type for example. The location zone is shown diagrammatically in FIG. 1 by the fixed part of the network (RR) which includes a switch of the mobile switching centre (MSC) which is connected firstly through a base station controller (BSC) to a base transceiver station (BTS) and then over a radio path to the radiotelephone terminal (TU), and secondly to an independently-routing telephone switch of the switched telephone network (RTC/STN).

According to a first example of client/server architecture of the invention, the server resource (MS) globally groups together elements of the fixed part of the radiotelephone network (RR) used for handling the movement of the mobile terminals, the security of communications with the mobile terminals, and incoming and outgoing calls with the mobile terminals in the network (RR). These elements in the server resource (MS) are mainly a visitor location register (VLR) connected at least to the switching centre (MSC) and containing characteristics, such as the identities and subscription profiles of the mobile terminals, and more precisely of the users possessing the chip cards (CP) in these, situated in the location zone, and a home location register (HLR) connected to several switches of the mobile service (MSC) through the signalling network of the radiotelephone system (RR).

As will be seen in what follows, the VLR register no longer assigns a temporary identity (TMSI) to identify each mobile terminal (TU) in the location zone, but is transparent to a respective anonymous identifier, such as a pseudonym (IA1, IA2) transmitted by each user terminal (TU) to identify itself to the server resource (MS) according to the invention. The communications for the visitor mobile radiotelephone terminals, such as the terminal (TU) shown in FIG. 1 and momentarily situated in the location zone served by the switch (MSC), are handled by the latter.

The home location register (HLR) is essentially a database, like the VLR register, which contains, for each mobile terminal (TU) and more precisely for each SIM card (CP), a unique user identifier (ID) attributed during the subscription of the user to the radiotelephone service, by writing the identifier (ID) into non-volatile EEPROM memory on the chip card (CP). The identifier (ID) also identifies the chip card (CP) and can be identical, at least in part, to the international identity (IMSI), in particular for a radiotelephone network of the GSM type. The home location register (HLR) records other characteristics associated with the users, such as their directory telephone numbers, their subscription profiles, etc.

As is already known, the home location register (HLR) works with an authentication centre (AUC), very frequently on the same platform as the home location register (HLR). The authentication centre performs authentication of the users, and contributes to the confidentiality of the data transiting over the radio interfaces between the mobile terminals (TU) and the base stations (BTS), running the authentication and key determination algorithms. The authentication centre thus generates confidential authentication keys and encryption keys attributed respectively to the users. In particular, according to the invention, the authentication centre (AUC) operates an asymmetrical algorithm (AA) whose private key (KPR) is stored in the authentication centre (AUC) and the home location register (HLR), and a symmetrical algorithm (AS), whose key is derived from a random number (R) according to a first embodiment of the invention, or operates only an asymmetrical algorithm (AA) with private key (KPR). For example, the asymmetrical algorithm with public key (AA) can be the E1 Gamal algorithm, or the Cramer-Shoup, or the RSAOAEP (Rivest, Shamir and Adleman-Optimal Asymmetric Encryption Padding). In a variant, the private key (KPR) is not common to all the users of the network (RR), but several private keys (KPR) are respectively attributed to user groups in correspondence with groups of user identifiers (ID), where these correspondences are recorded in the home location register (HLR).

As is already known, the SIM microcontroller card (CP) mainly includes a microprocessor (PR) and three memories (M1, M2 and M3).

According to the invention, a random number generator (GA) is implemented in hardware, in or in connection with the processor (PR) on the chip card. The generator (GA) generates a random number (R) which participates in the anonymous identification of the chip card (CP) in response to a request from memory M1. In a variant, the random number generator is included in software form in ROM memory M1.

Memory M1 is of the ROM type and includes the operating system of the card and very frequently a virtual machine on which the operating system depends. Authentication, communication and application algorithms, and particularly the AA and AS algorithms, or the AS algorithm to according to the invention, are implemented in memory M1. Memory M2 is a non-volatile memory of the EEPROM type, containing characteristics that are associated with the user, such as the identifier (ID) of the user with the chip card (CP), the subscription profile, a directory of telephone numbers, a confidential code, etc. Memory M2 also contains a public key (KPU) for the asymmetrical algorithm (AA) implemented in memory M1, associated with the private key (KPR) by the home location register (HLR) in the server resource (MS), and in a variant, also respectively in correspondence with the identifiers (ID) of the users of a group. Memory M3 is RAM memory used for processing of the data to be exchanged between the processor (PR) and the microcontroller included in the mobile terminal (TU).

The two embodiments of the identification process of a user terminal resource (TU, CP) by a server resource (MS) according to the invention, are described below with reference to the first example shown in FIG. 1.

The identification process according to the invention occurs at the beginning (E0) of a session to be set up between the terminal resource composed of at least the chip card SIM (CP) and the server resource (MS), through the radiotelephone network (RR), after the switching on of the terminal (TU) for example, or during any setting-up of an outgoing call in the terminal (TU). More generally, the process of the invention can occur every time the chip card has to transmit its identifier to the fixed network using the previous technique. Thus the process of the invention can precede one authentication at least of the chip card (CP) by the home location register (HLR) and the authentication centre (AUC).

According to the first embodiment of the authentication process shown in FIG. 2, steps E1 to E6 following on from the initial step (E0) to determine an anonymous identifier (IA1), are essentially executed in the chip card (CP), and steps E6 to E15, to retrieve the user identifier (ID), are executed in the server resource (MS) of the radiotelephone network (RR).

At step E1, the random number generator (GA) in the chip card (CP) supplies a random number (R) which is stored in memory M3 to be applied to the asymmetrical algorithm (AA) and as a key to the symmetrical algorithm (AS), implemented in memory M1.

The public key (KPU) and the user identifier (ID) are read from memory at virtually simultaneous steps E2 and E3, to be applied respectively to algorithms AA and AS. Application of the generated random number (R) as data to the asymmetrical algorithm (AA) with the public key (KPU) produces an encrypted random number (RC) at step E4. In parallel with the previous step (E4), application of the generated random number (R), as a unique confidential key, and of the identifier (ID) of the user as data, to the symmetrical algorithm (AS), produces an encrypted identifier (IC) at step E5. In practice, part of the identifier (ID) is applied to the AS algorithm. This part includes only the confidential MSIN number (Mobile Subscriber Identification Number) of the user included in the IMSI identifier of the user and identifying the user in the network (RR).

Then, after execution of the AA and AS algorithms, the processor (PR) concatenates the encrypted random number (RC) and the encrypted identifier (IC) into an anonymous identifier (IA1) which is written into memory M2. The IA1 identifier acts as a pseudonym of the user, that is of the SIM card (CP) as a client of the server resource (MS). This concatenation is followed by transmission of the IA1 pseudonym in a message through the terminal (TU) and the radiotelephone network (RR) to the server resource (MS) at step E6. The pseudonym (IA1) can be transmitted with the prefixes MCC (Mobile Country Code) and MNC (Mobile Network Code) of the IMSI identifier of the user, so that the home location register (HLR) recognises the country code of the user and the code of the network (RR).

In the server resource (MS), the VLR register re-transmits the anonymous identifier (IA1) to the home location register (HLR) which, in cooperation with the authentication centre (AUC), executes the following steps, E7 to E13.

After a writing of the random number (RC) and the identifier (IC) making up the received anonymous identifier (IA1) into the home location register (HLR) at step E7, the authentication centre (AUC) reads the private key (KPR) at step E8 in order to applied it, together with the received encrypted random number (RC) to the asymmetrical algorithm (AA) at step E9. The authentication centre (AUC) thus retrieves the generated random number (R) constituting the result of executing algorithm AA, and applies it as a key to the symmetrical algorithm (AS), which receives, in the form of data, the received encrypted identifier (IC) read from the home location register (HLR) at step E10.

The user identifier (ID) initially applied at step E5 in the chip card (CP) is then retrieved as output from the symmetrical algorithm (AS) by the home location register (HLR) so that the latter can verify that it has been written into its database at step E11. If the retrieved identifier (ID) is not recognised, then the requested session, a call in this instance, is refused at step E12. Otherwise, the home location register (HLR) continues the session at step E13, indicating this to the VLR register, which orders the authentication of the chip card (CP) by the HLR-AUC pair, or a mutual authentication of these.

After step E13, the chip card (CP) automatically transmits the pseudonym (IA1) read from memory M2 to the server resource (MS) every time the chip card must identify itself to the latter. At any time however, as indicated at step E14, the chip card (CP) can decide to change the pseudonym (IA1) by again calling the random number generator (GA) so that it generates another random number (R) at step E1. The generation of another random number (R) by the generator (GA) at step E1, and therefore the execution of a new cycle of steps E1 to E14, can be periodic in the terminal resource, in order to have the chip card (CP) identified periodically by the server resource (MS) by determining another anonymous identifier (IA1). According to another variant, the generation of another random number (R) by the generator (GA) at step E1, and therefore the execution of a cycle of steps E1 to E14, can occur under the control of the user or not, following, for example, at least one of the following events in the terminal resource composed of the terminal (TU) and the chip card (CP): switching on of the terminal (TU), preceding at least one authentication of the card to the chip card (CP) by the HLR-AUC pair, and the identification of a user of the terminal (TU) by the entry of a confidential PIN number on the keypad of the terminal, the setting-up of a call, the setting-up of a session between the terminal resource and the server resource, substitution of the server resource (MS) by another server resource, for example during a transfer from the VLR register to another VLR register of the network (RR) with which is the terminal (TU) is now associated, activation of a service application such as the sending of a short message or of a connection to a WAP portal (Wireless Application Protocol) for mobile terminals to communicate with a web site server.

In order to improve the security of the identification process, the home location register (HLR), or more generally the server resource (MS), can decide at any time to change the current private key (KPR) into another private key and, as a consequence, the current public key (KPU) into another public key, as indicated at step E15. In this event, preferably after an authentication of the VLR register by the card (CP), the home location register (HLR) orders the downloading of the other public key (KPU) through the VLR register, the radiotelephone network (PR) and the terminal (TU), into memory M2 of the chip card (CP), so that the said other public key (KPU) is used for the next executions of the asymmetrical algorithm (AA) at step E4. The other public key (KPU) is transmitted in a secure message by the VLR register through the execution of an algorithm, a symmetrical algorithm for example, whose confidential key has been recorded initially in memory M2 of the chip card (CP) in order to authenticate the said other public key (KPU) in the processor (PR).

According to a second embodiment, shown in FIG. 3, at the beginning (E0) of a session to be established between the chip card (CP) in the terminal (TU) and the server resource (MS), as described previously, the process includes firstly steps E21 to E26, essentially executed in the SIM card (CP), and then steps E27 to E33 in the server resource (MS). For this second embodiment, ROM memory M1 and the authentication centre (AUC) include only an asymmetrical algorithm with public key (AA).

Following step E0, the random number generator (GA) generates a random number (R) which is written into memory M3 at step E21. The identifier (ID) of the chip card (CP) is read from memory M2 at step E22, so that the processor (PR) concatenates the generated random number (R) and at least part of the read identifier (ID) at step E23. The public key (KPU) is read from memory M2 at step E24, to be applied, with the combination produced [R, ID], as data to the asymmetrical algorithm (AA) at step E25. The asymmetrical algorithm (AA) is then executed at step E25, and produces an anonymous identifier (IA2) which is written into memory M2, and which constitutes a pseudonym, that is of the SIM card (CP) held by the user, at step E26. The anonymous identifier (IA2) representing the encrypted identifier (ID) is transmitted in a message by the chip card (CP) through the terminal (TU) and the radiotelephone network (RR) to the server resource (MS).

The visitor location register (VLR) re-transmits the anonymous identifier (IA2) to the home location register (HLR) which writes it into memory at step E27. At step E28, the private key (KPR) is read from the home location register (HLR) which executes the following steps, E29 to E33, in cooperation with the authentication centre (AUC). The read key (KPR) and the identifier IA2, are applied as data to the asymmetrical algorithm (AA) in the authentication centre (AUC) at step E29. Execution of the algorithm (AA) enables the random number (R), and particularly the user identifier (ID), to be retrieved at step E30.

Step E30 is followed by steps E31 to E35, which are similar to steps E11 to E15 respectively, and which relate to verification of the association of the retrieved identifier (ID) with the database in the home location register (HLR), the automatic transmission of the anonymous identifier (IA2) by the chip card (CP) every time the latter has to identify itself to the server resource (MS), the preferably automatic changing of the anonymous identifier (IA2) either periodically or following at least one of the events listed previously, and the downloading of another public key (KPU) into the chip card (CP) after a change of private key (KPR) in the server resource (MS).

According to a variant of the embodiments described above, the visitor location register (VLR) in the network (RR) contains the AA and AS algorithms, which are executed at steps E9 and E10, or the AS algorithm which is executed at step E29, instead of being implemented and executed in the authentication centre.

In accordance with a second example of the client/server architecture according to the invention, shown in FIG. 4, the terminal resource is a personal computer (PC) or a personal digital assistant (PDA) or any other electronic object, portable in particular, which is connected to such a telecommunication network (RT). The network (RT) can include the internet network and an access network such as the switched telephone network, or indeed can consist of a local network, such as a WLAN wireless local network (Wireless Local Area Network). In particular, in relation to the invention, the terminal (PC) includes a memory (ME), preferably of the secure type, in which the AA and AS algorithms or the AA algorithm are implemented, and in which the user identifier (ID) and the public key (KPU) are stored. The terminal (PC) contains a browser playing the role of client in relation to a server (SE), such as the server resource according to the invention, connected to the telecommunication network (RT). In the server (SE), the AA and AS algorithms according to the first implementation or the AA algorithm according to the second implementation are also implemented, and the private key (KPR) and the public key (KPU) are stored, preferably in correspondence with an identifier (ID) of a user of the terminal (PC), such as a log-in user, as in the server resource (MS) according to the first example. In this example, the server (SE) can, for instance, be a web site or portal which at least handles the access to a database to which the user of the terminal (PC) is subscribed.

Steps similar to those described at E1 to E15, or E21 to E35, are executed partly in the terminal (PC) and partly in the server (SE) in order to identify a user of the terminal (TU) by comparison of the identifier (ID) retrieved by the server (SE) and the user identifier stored in the server. These steps can precede others security steps relating in particular to an authentication of the user by verification of a password of the user.

In a variant, the terminal (PC) is equipped with a reader for an additional chip card (CA) which is similar to the chip card (CP) according to the first example shown in FIG. 1, that is the card whose memories M1 and M2 contain the AA and AS algorithms according to the first embodiment, or the AA algorithm according to the second embodiment, the identifier (ID) of the user-holder of the card (CA) and therefore of the card (CA) itself, and the public key (KPU). As in the example shown in FIG. 1, the terminal (PC) in this variant is transparent to the communications between the server (SE) and the card (CA) regarding the identification of the card (CA) by the server (SE) according to the invention. The link between the card (CA) and the terminal (PC) is conventional, and can be a link by electrical contact, a contactless link, or a proximity radio link of the Bluetooth or 802.11 type.

According to yet another variant of the second example shown in FIG. 4, the chip card (CA) has stored only the identifier (ID) and the public key (KPU) in its EEPROM memory (M2), and the AA and AS algorithms, or the AA algorithm, are implemented in the terminal (PC).

In these variants of the second example, the terminal (PC) and the additional chip card (CA) can be a bank terminal and a credit card respectively, or a point-of-sale terminal and an electronic purse.

1. A process to identify a user terminal resource or a user of the terminal resource by a server resource in a telecommunication network, using a first identifier, where an asymmetrical algorithm with public key is implemented in the terminal resource, comprising the following steps:
generating a random number in the user terminal resource,
determining in the terminal resource a second identifier as a function of the random number, at least from part of the first identifier and from the result of executing the asymmetrical algorithm to which at least the random number is applied,
transmitting the second identifier to the server resource, and
in the server resource, retrieving the first identifier at least by executing the asymmetrical algorithm to which a private key and, at least partially, the second identifier are applied, so that the server resource verifies that the first retrieved identifier is written into a memory of the server resource.

2. A process according to claim 1, further including the step of authenticating the terminal resource by the server resource subsequent to the steps of claim 1.

3. A process according to claim 1, in which the determination in the terminal resource includes application of the generated random number to the asymmetrical algorithm with the public key to produce an encrypted random number, application of the generated random number and the first identifier to a symmetrical algorithm implemented in the terminal resource, to produce an encrypted identifier, and concatenation of the encrypted random number and of the encrypted identifier in the second identifier to be transmitted to the server resource, and wherein the retrieval in the server resource includes application of the encrypted random number to the asymmetrical algorithm with the private key, in order to retrieve the generated random number, and application of the retrieved random number and the encrypted identifier to the symmetrical algorithm, in order to retrieve the first identifier.

4. A process in accordance with claim 1, wherein the determination in the terminal resource includes application of the generated random number concatenated to the first identifier, to the asymmetrical algorithm with the public key to produce the second identifier to be transmitted to the server resource, and wherein the retrieval in the server resource includes application of the second identifier to the asymmetrical algorithm with the private key in order to retrieve the first identifier.

5. A process according to claim 1, further including the steps of changing the public key and the private key for the asymmetrical algorithm in the server resource, and downloading the changed public key from the server resource to the terminal resource.

6. A process according to claim 1, wherein the generation of the random number is periodic in the terminal resource.

7. A process according to claim 1, wherein the generation of the random number occurs following at least one of the following events in the terminal resource: switching on the terminal resource, setting-up a call, setting-up a session between the terminal resource and the server resource, substitution of the server resource for another server resource, or activation of a service application.

8. A user terminal resource identifying itself, or identifying a user of the latter, to a server resource, through a telecommunication network, using a first identifier, an asymmetrical algorithm with a public key implemented in the terminal resource, comprising:
a resource to generate a random number, and
a resource to determine a second identifier as a function of the random number, at least from part of the first identifier and from the result of executing the asymmetrical algorithm to which at least the random number is applied in order to transmit the second identifier to the server resource, which retrieves the first identifier at least by executing the asymmetrical algorithm to which a private key and, at least partially, the second identifier are applied, and which verifies that the first retrieved identifier is written into a memory of the server resource.

9. A user terminal resource according to claim 8, wherein the resource to generate a random number (GA) and the resource to determine a second identifier are included in a portable electronic object of the chip card type.
